(19) United States
(12) Patent Application Publication
(10) Pub. No.: US 2026/0063197 A1
(43) Pub. Date: Mar. 5, 2026

(54) ACTIVE COOLING SYSTEM

(71) Applicant: American Axle & Manufacturing, Inc., Detroit, MI (US)

(72) Inventors: Piotr Madela, Wroclaw (PL); Lukasz Szydelko, Strzegom (PL); Rafal Jaroszewski, Swiebodzice (PL)

(21) Appl. No.: 18/817,427

(22) Filed: Aug. 28, 2024

(51) Int. Cl. F16H 57/04; F16H 57/02; F16H 57/031

(52) U.S. Cl. CPC F16H 57/0424; F16H 57/0413; F16H 2057/02043; F16H 57/031

(57) ABSTRACT

A rear drive unit has a carrier housing defining a cavity configured to contain lubricating fluid and an opening. The unit includes a cover assembly having a cover and a heat exchanger. The cover is configured to be secured to the carrier housing and close the opening and has an interior surface facing the cavity and an opposing exterior surface. The heat exchanger is fixedly coupled to the exterior surface and has an inner surface facing the cover and an opposing outer surface. The cover assembly includes a cooling channel that fluidly couples an inlet port and an outlet port in a U-shaped coolant flow path. The inlet and outlet ports are coupled to a cooling system to control a flow of coolant through the cooling channel.

### FIELD

The present disclosure relates to an active cooling system for a vehicle driveline component.

### BACKGROUND

This section provides background information related to the present disclosure which is not necessarily prior art.

An automotive vehicle can include a rear drive unit such as a rear differential drive unit that includes rotating and/or moving parts that require the use of lubricating fluid. A characteristic of the lubricating fluid that can affect durability, performance, and efficiency (e.g., fuel economy) is temperature. It would be useful to provide a configuration that can cool the lubricating fluid during operation.

### SUMMARY

In accordance with one implementation, an apparatus is provided for a vehicle driveline component, such as a rear differential, which has a carrier housing defining a cavity and an opening. The apparatus includes a cover configured to be secured to the carrier housing and close the opening. The cover includes an interior surface configured to face the cavity and an exterior surface opposite the interior surface. The apparatus further includes a heat exchanger fixedly coupled to the exterior surface of the cover, wherein the heat exchanger has an inner surface facing the cover and an outer surface opposite the inner surface. The cover and the heat exchanger form a cooling channel that fluidly couples an inlet port and an outlet port in a U-shaped coolant flow path. The inlet port and the outlet port are configured to be coupled to a cooling system to control a flow of coolant through the cooling channel.

In accordance with another implementation, a vehicle driveline component is provided and comprises a carrier housing defining a cavity and an opening, wherein an input pinion, a ring gear, and a differential are received in the cavity. The pinion is rotatable relative to the carrier housing about a first axis, the ring gear is in mesh with the pinion, and the ring gear is fixedly coupled to the differential. The differential is supported for rotation about a second axis relative to the carrier housing.

The vehicle driveline component further includes a cover assembly including a cover configured to be secured to the carrier housing and close the opening. The cover includes an interior surface configured to face the cavity and an exterior surface opposite the interior surface. The cover assembly further includes a heat exchanger fixedly coupled to the exterior surface and having an inner surface facing the cover and an opposing outer surface. The cover assembly further includes a cooling channel having an inlet port and an outlet port, where the cooling channel fluidly couples the outlet port to the inlet port in a U-shaped coolant flow path. The inlet port and the outlet port are configured to be coupled to a cooling system to control a flow of coolant through the cooling channel.

Further areas of applicability will become apparent from the description provided herein. The description and specific examples in this summary are intended from purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagrammatic view depicting an implementation of a rear drive unit having active cooling;

FIG. 2 is a top, front isometric view depicting an implementation of a cover and a heat exchanger of an active cooling system;

FIG. 3 is a top, rear isometric view depicting the implementation of the cover and heat exchanger of FIG. 2;

FIG. 4 is a bottom, isometric view depicting the heat exchanger of FIG. 2;

FIG. 5 is a top view depicting the cover of FIG. 2 and showing sealing paths;

FIG. 6 is a top view depicting the heat exchanger affixed to the cover;

FIG. 7 is a front isometric view of the FIG. 6;

FIG. 8 is a bottom isometric view of FIG. 6;

FIG. 9 is a cross-sectional view of the heat exchanger and cover of FIG. 6 taken substantially along line 9-9;

FIG. 10 is a cross-sectional view of the heat exchanger and cover of FIG. 6 taken substantially along line 10-10; and

FIG. 11 is a cross-sectional view of the heat exchanger and cover of FIG. 6 taken substantially along line 11-11.

Corresponding reference numerals indicate corresponding parts throughout the several views of the drawings.

### DETAILED DESCRIPTION

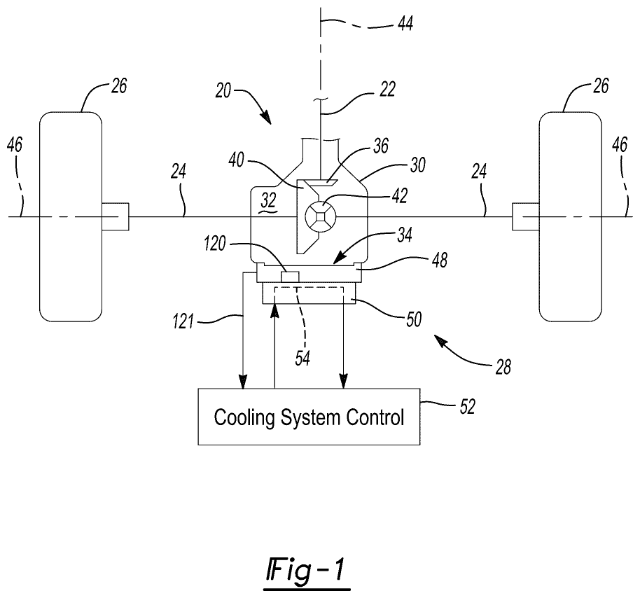

FIG. 1 is a diagrammatic view depicting an implementation of an active cooling system in accordance with the teachings of the disclosure, for a vehicle driveline component, such as a rear drive unit 20 of an automotive vehicle, and more particularly a rear differential drive unit. The unit 20 receives mechanical rotary power by way of a driveshaft 22 and is configured generally to provide output mechanical rotary power to a pair of half shafts or half axles 24 that are connected to respective wheels 26.

FIG. 1 further shows an apparatus for actively cooling the differential cavity/housing of the rear drive unit 20, identified as cover assembly 28, as well as a carrier housing 30 to which the cover assembly is mounted. The carrier housing 30 defines a cavity 32 and an opening 34.

The unit 20 further includes an input pinion 36 coupled to driveshaft 22, a ring gear 40, and a differential 42. The pinion 36, the ring gear 40, and the differential 42 are all received in the cavity 32. The pinion 36 is rotatable relative to the carrier housing 30 about a first axis 44. The ring gear 40 is in mesh with the pinion 36 where the ring gear 40 is fixedly coupled to the differential 42. The differential 42 is supported for rotation about a second axis 46 relative to the carrier housing 30.

The cover assembly 28 includes a cover 48 and a heat exchanger 50 fixedly coupled to the cover 48. The cover 48 in turn is configured to be secured to the carrier housing 30 and is configured to close the opening 34, which contains lubricating fluid in the cavity 32.

One characteristic of the lubricating fluid that can affect one or more of the durability, performance, and efficiency of the rear drive unit 20 (and components thereof) is temperature. The cover assembly 28 is coupled to an active cooling system control 52, which controls a flow of coolant through a cooling channel 54 formed in and/or in between the cover 48 and the heat exchanger 50.

FIG. 1 also shows a temperature sensor 120 comprising a rear axle oil temperature sensor that is disposed in the cover 48 and is located in sensing proximity to the lubricating oil contained in the cavity 32. The temperature sensor 120 is configured to provide a temperature indicative signal 121 indicative of the temperature of the lubricating oil wherein the signal 121 is provided to the cooling system control 52. Coolant, in an implementation, is delivered from the vehicle cooling system, for example, a vehicle water pump (not shown) configured to pump coolant through a vehicle coolant hose to a coolant inlet of the cover assembly 28. A coolant outlet of the cover assembly 28 is also coupled to the vehicle cooling system. A flow rate of the coolant is managed by the cooling system control 52 using the temperature indicative signal 121 as feedback. In an implementation, the cooling system control 52 may be the original equipment manufacturer (OEM) vehicle cooling system control. The cooling system control 52 manages the lubricating oil temperature in accordance with the temperature indicative signal 121, such as by adjusting the coolant flow rate according to the temperature indicative signal 121 (e.g., increasing the flow rate as per increases in the lubricating oil temperature and decreasing the flow rate as per decreases in the lubricating oil temperature).

The benefits achieved through active cooling system embodiments consistent with the teachings of the instant disclosure include, without limitation: (1) improved performance—various active cooling system implementations ensure improved and/or optimal rear differential temperatures, enhancing performance while reducing overheating risks; (2) increased durability—consistent temperatures prolong drivetrain component lifespan as well as cutting maintenance costs; and (3) enhanced efficiency—minimizing heat buildup improves drivetrain efficiency and fuel economy.

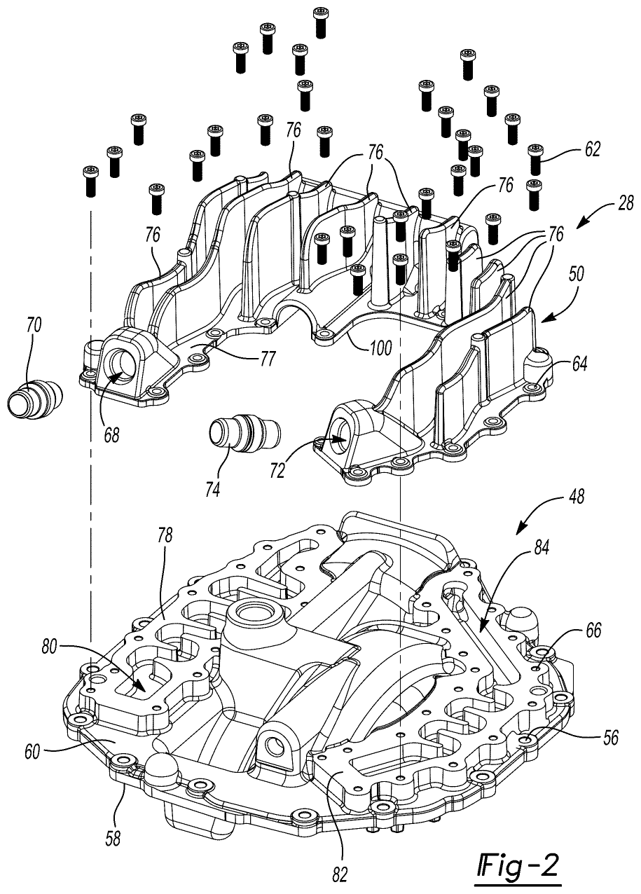

FIG. 2 is a top, front, isometric view depicting an implementation of the cover assembly 28 of FIG. 1 including cover 48 and heat exchanger 50. The cover 48 is configured to be secured or mounted to the carrier housing 30 (FIG. 1) and for this purpose is provided with a plurality of through-holes 56 (best shown in FIG. 6). The holes 56 may be aligned with threaded bores in the carrier housing 30 wherein conventional threaded fasteners can be used to secure the cover 48 to the carrier housing 30.

The cover 48 further includes an interior surface 58 (the underside in FIG. 2) that faces the cavity 32 when installed and an exterior surface 60 opposite of the interior surface 58.

The heat exchanger 50 includes an inner surface 100 that faces the exterior surface 60 of the cover 48 and an outer surface 77. The heat exchanger 50 is fixedly coupled to the surfaces of bosses 78 and 82. In an implementation, the heat exchanger 50 is fixedly coupled to the cover 48 using a plurality of threaded fasteners 62. The heat exchanger 50 includes a corresponding plurality of through-holes 64 and the cover 48 includes a further corresponding plurality of aligned, threaded bores 66. In FIG. 2, only one fastener 62, hole 64, and bore 66 are identified by reference numeral so as to not obscure other features of the implementation.

The cover assembly 28 includes the cooling channel 54 having an inlet port and an outlet port. In an implementation, the heat exchanger 50 includes the first port, designated first port 68 which is configured to receive a first coolant connector 70 as well as the second port, designated second port 72 which is configured to receive a second coolant connector 74. The connectors 70, 74 may include respective O-rings or similar sealing on an outside surface such that when inserted into their respective ports, a fluid-tight coupling is made. In an implementation, the first port 68 is an inlet port for receiving coolant from the cooling system control 52 and the second port 72 is an outlet port for the return of coolant to the cooling system control 52 after having passed through the cover assembly 28. The cooling channel 54 fluidly couples the first port 68 with the second port 72 in a predetermined coolant flow path. Additionally, the first and second connectors 70, 74 are fluidly connected to the cooling system control 52, which controls the flow of coolant to the inlet/outlet ports 68, 72 and through the cooling channel 54. In an implementation, the coolant flow path is a generally U-shaped coolant flow path, as will be described in greater detail hereinafter.

The heat exchanger 50 further includes a plurality of fins 76. The fins 76 extend in a direction away from the outer surface 77. In an implementation, ten fins 76 are included and are used to increase a surface area exposed to an ambient environment for facilitating the transfer of heat away from the cover assembly 28 to the ambient environment, which constitutes a direct transfer from the heat exchanger 50 and an indirect transfer from the cover (via the heat exchanger).

The cover 48 and the heat exchanger 50 each comprise thermally conductive material, which in an implementation may be aluminum material and in a still further implementation, each may be an aluminum cast product. The use of aluminum provides for a lightweight and durable construction. The lightweight configuration contributes to better handling of vehicles incorporating the same as well as improved fuel economy for vehicles incorporating the same. It should be understood that other suitable thermally-conductive materials may be used for the cover 48 and/or the heat exchanger 50.

With continued reference to FIG. 2, the cover 48 includes a first boss 78 having a first groove 80 formed therein having a first serpentine shape and a second boss 82 having a second groove 84 formed therein having a second serpentine shape, where the first and second serpentine shapes are different. The serpentine shapes increase a length of the coolant flow path. Each boss 78, 82 is raised relative to the surface 60. The second groove 84 is spaced laterally apart from the first groove 80 and grooves 80, 84 are not contiguous. The grooves 80, 84 are part of the cooling channel 54.

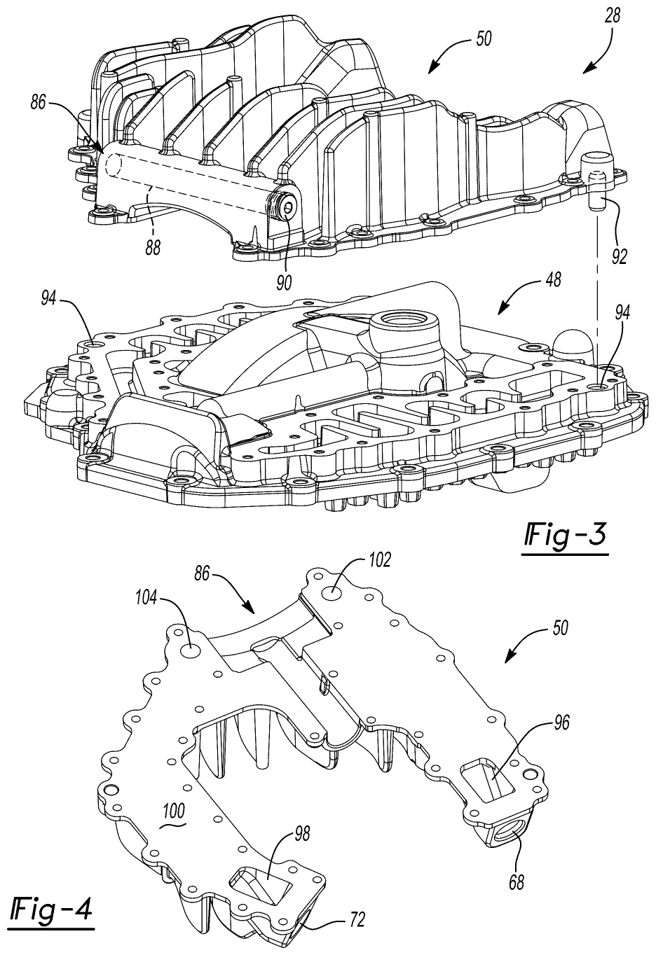

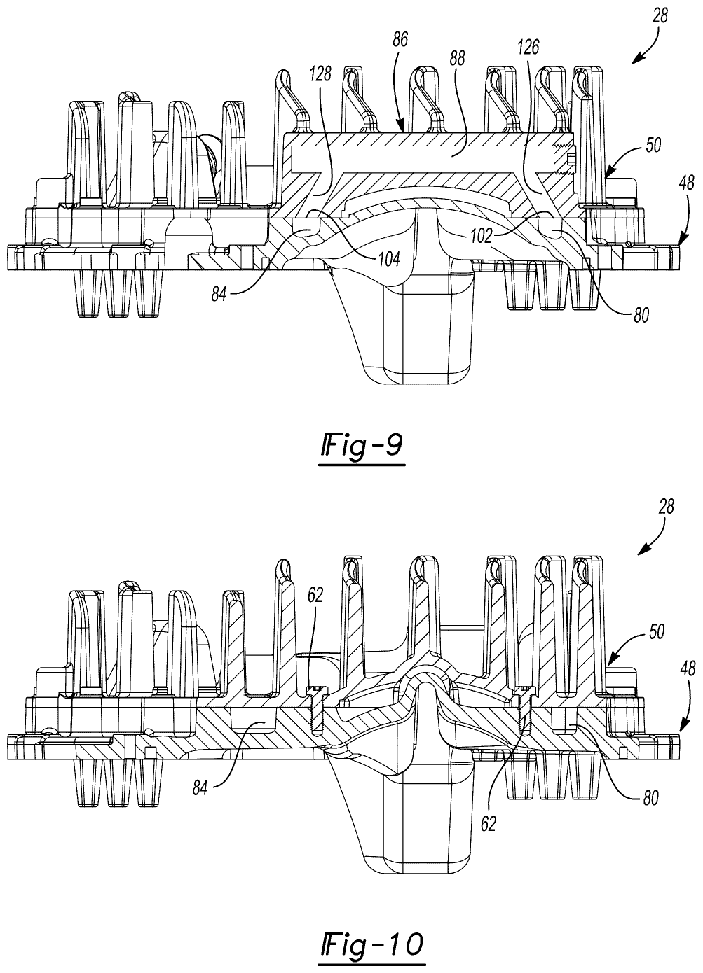

FIG. 3 is a top, rear isometric view depicting the implementation of the cover 48 and heat exchanger 50 of FIG. 2. The heat exchanger 50 has a fluid transfer conduit 86 that includes a through-bore 88. The bore 88 has inlet and outlet bores (best shown in FIG. 9). The conduit 86 further includes a removable (e.g., threaded) plug 90, which can be used to gain access to the bore 88.

In reference to FIGS. 2 and 3, it should be appreciated that the heat exchanger 50 has a first side (best shown in FIG. 2) in which the first port 68 and second port 72 are defined as well as a second side opposite the first side (best shown in FIG. 3), in which the fluid transfer conduit 86 is defined.

In addition, FIG. 3 shows a dowel 92 that is used in aligning the heat exchanger 50 with the cover 48. The dowel 92 is positioned to be inserted into a blind bore 94. In an implementation, another dowel 92 (not visible) is used for the same purpose and cooperates with another, diametrically located, blind bore 94.

FIG. 4 is a bottom, isometric view depicting the heat exchanger 50 of FIG. 2, which shows features involved in forming the cooling channel 54. In an implementation, a first aperture 96 is fluidly coupled to the first port 68, a second aperture 98 is fluidly coupled to the second port 72. The first and second apertures 96, 98 extend into the surface 100. The inner surface 100 may be generally planar. The fluid transfer conduit 86 further includes first and second openings 102, 104 which are in fluid communication with the bore 88 (FIG. 3).

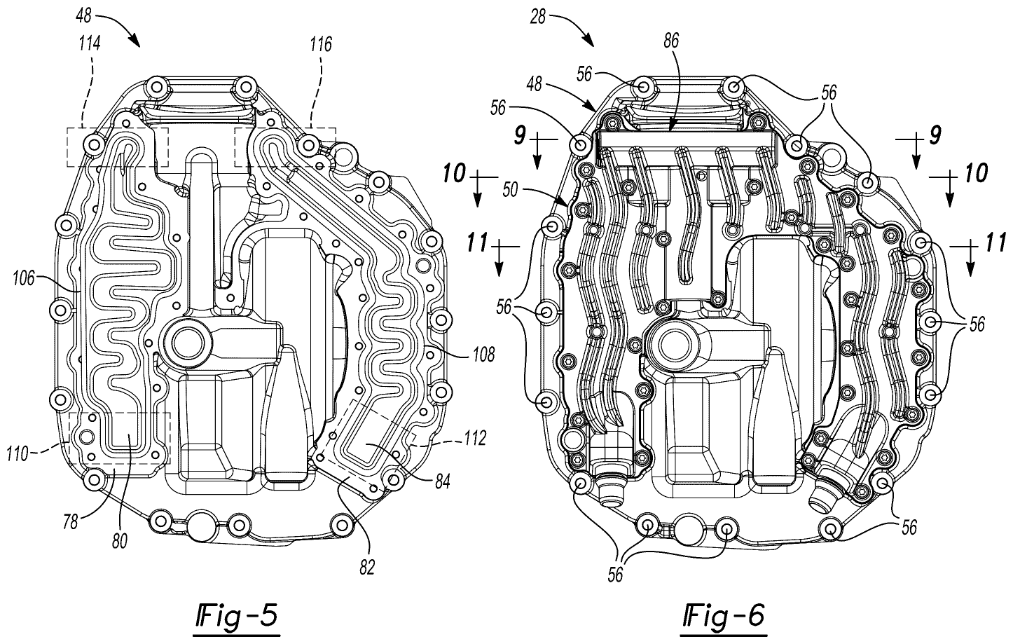

FIG. 5 is a top view depicting the cover 48 of FIG. 2. In an implementation, when the heat exchanger 50 is secured to the cover 48, the inner surface 100 of the heat exchanger 50 engages the raised first and second bosses 78, 82. The heat exchanger 50 thus closes the open sides of the grooves 80, 84 (i.e., the upper sides as shown in FIG. 5) to create a pair of passages: a first passage is formed by the first groove 80 and the inner surface 100 and a second passage is formed by the second groove 84 and the inner surface 100. The heat exchanger 50 fluidly couples, by way of the fluid transfer conduit 86 formed therein, the closed grooves (i.e., passages) with each other. Also, the first port 68 and the second port 72 are fluidly coupled to a respectively associated one of the first and second grooves 80, 84.

To ensure a fluid-tight cooling channel, sealing material such as an appropriate gasket or a sealant may be applied along both paths 106, 108 that respectively encompass grooves 80, 84. The sealing material is applied before mounting the heat exchanger 50 to the cover 48. In an implementation, the sealing material may comprise RTV sealant (room temperature vulcanizing sealant). In terms of orientation when mounting, the aperture 96 (FIG. 4) generally aligns with and overlies an area 110, the aperture 98 (FIG. 4) generally aligns with and overlies an area 112, the opening 102 (FIG. 4) generally aligns with and overlies an area 114, and the opening 104 (FIG. 4) generally aligns with and overlies an area 116.

The cooling channel 54 is defined along a generally U-shaped coolant flow path, wherein a first leg of the U-shaped coolant flow path includes the first groove 80, a second leg of the U-shaped coolant flow path includes the second groove 84, and a bight section of the U-shaped coolant flow path includes the fluid transfer conduit 86, which fluidly connects the first and second legs (i.e., the first and second grooves 80, 84).

FIG. 6 is a top view depicting the cover assembly 28 showing the heat exchanger 50 affixed to the cover 48. FIG. 6 more fully shows an extent of the holes 56 used to secure or mount the cover 48 to the carrier housing 30. In an implementation, there are sixteen holes. It should be understood that the number of holes 56 and the pattern into which the holes 56 are arranged on the cover 48 may be selected so as to match that of a pre-existing carrier housing hole pattern, so that embodiments consistent with the instant teachings may be used as a retrofit and/or upgrade option, and provide active cooling as described herein.

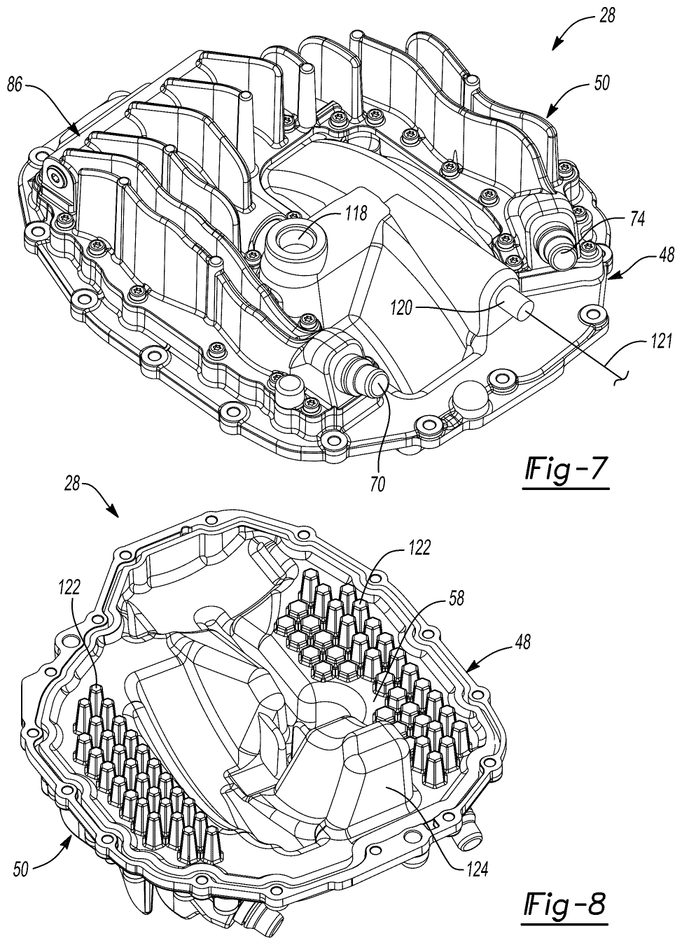

FIG. 7 is a front isometric view of the cover assembly 28 of FIG. 6. In an implementation, the cover 48 include a fill and level check hole 118 (i.e., to check lubricating fluid level and/or to add lubricating fluid) as well as an access aperture for receiving the temperature sensor 120—the sensor 120 being shown in block form in FIG. 1. As described herein, the sensor 120 is configured to sense the temperature of the lubricating oil and output the temperature indicative signal 121 as shown.

FIG. 8 is a bottom, isometric view of the assembled cover assembly 28 of FIG. 6. The cover 48 includes a plurality of projections 122 extending away from the interior surface 58 in a direction towards the cavity 32 (in reference to when the cover 48 is mounted to the carrier housing 30). The number, size/geometry, and spacing of the individual projections 122 may vary as in the implementation shown in FIG. 8. The projections 122 are configured to increase a surface area of the underside of the cover 48 that comes into contact with lubricating fluid, thereby facilitating heat transfer from the lubricating fluid and/or differential cavity generally to the cover 48. Through thermal transfer, heat can then be transferred both to the flowing coolant through the cooling channel 54 as well as radiated to an ambient environment via the heat exchanger 50 (e.g., via finds 76). In an implementation, the cover 48 includes a sump 124 extending from the interior surface 58 and configured for receiving/holding lubricating fluid.

FIG. 9 is a cross-sectional view of the cover assembly 28 of FIG. 6 taken substantially along line 9-9. In addition to bore 88, the fluid transfer conduit 86 further includes a first connecting duct 126 and a second connecting duct 128. The first connecting duct 126 includes the opening 102 (see also FIG. 4) and the second connecting duct 128 includes the opening 104 (see also FIG. 4).

FIG. 10 is a cross-sectional view of the cover assembly 28 of FIG. 6 taken substantially along line 10-10. FIG. 10 shows fasteners 62 securing the heat exchanger 50 to the cover 48. In addition, FIG. 10 shows a section through the first groove 80 and a section through the second groove 84.

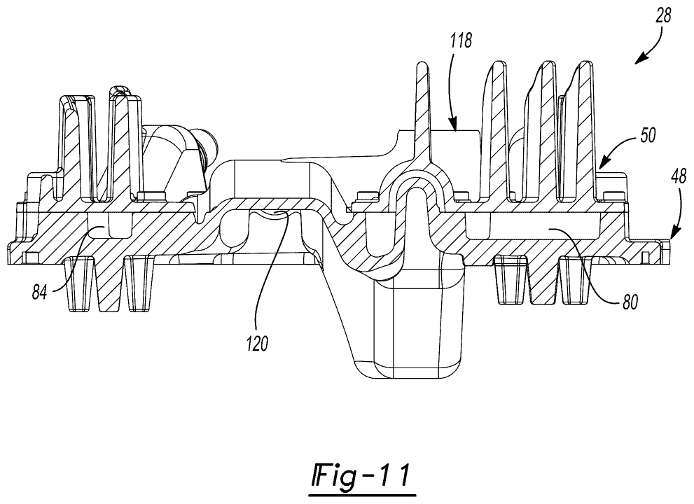

FIG. 11 is a cross-sectional view of the cover assembly 28 of FIG. 6 taken substantially along line 11-11, which shows the temperature sensor 120. In addition, FIG. 11 shows a section through the first groove 80 and a section through the second groove 84.

The active cooling system disclosed in various implementations feature integration of the lubricant oil cooling function with the carrier (rear differential) housing cover and is configured to actively manage heat dissipation within the rear differential housing. Further, efficient coolant flow paths, for example, formed in part by the serpentine grooves 80, 84, maximize heat transfer and thermal regulation. Still further, various heat exchange surfaces and structures are optimized for effective heat dissipation (e.g., projections 122 and fins 76).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An apparatus for a vehicle driveline component having a carrier housing defining a cavity and an opening, the apparatus comprising:
a cover configured to be secured to the carrier housing and close the opening, the cover including an interior surface configured to face the cavity and an exterior surface opposite the interior surface; and
a heat exchanger fixedly coupled to the exterior surface of the cover, the heat exchanger having an inner surface facing the cover and an outer surface opposite the inner surface;
wherein the cover and the heat exchanger form a cooling channel that fluidly couples an inlet port and an outlet port in a U-shaped coolant flow path, and wherein the inlet port and the outlet port are configured to be coupled to a cooling system to control a flow of coolant through the cooling channel.

2. The apparatus of claim 1 wherein the cover includes a first groove and a second groove spaced apart from the first groove, and wherein the heat exchanger includes a fluid transfer conduit configured to fluidly connect the first and second grooves.

3. The apparatus of claim 2 wherein the heat exchanger includes a first side and a second side opposite the first side, and wherein the heat exchanger includes the first port and the second port at the first side and the fluid transfer conduit at the second side.

4. The apparatus of claim 2 wherein the first groove has a first serpentine shape and the second groove has a second serpentine shape different from the first serpentine shape.

5. The apparatus of claim 2 wherein a first leg of the U-shaped coolant flow path comprises the first groove, a second leg of the U-shaped coolant flow path comprises the second groove, and a bight section of the U-shaped coolant flow path comprises the fluid transfer conduit.

6. The apparatus of claim 1 wherein the cavity is configured to contain lubricating fluid, and wherein the cover includes a plurality of projections extending from the interior surface towards the cavity and configured to facilitate heat transfer from the lubricating fluid to the cover.

7. The apparatus of claim 1 wherein the cavity is configured to contain lubricating fluid, and wherein the cover further includes a lubricating fluid sump extending from the interior surface towards the cavity.

8. The apparatus of claim 1 wherein the heat exchanger includes a plurality of fins extending away from the outer surface.

9. The apparatus of claim 1 wherein the flow of coolant through the cooling channel is configured to transfer heat from the cover and the heat exchanger to the coolant.

10. A vehicle driveline component, comprising:
a carrier housing defining a cavity and an opening wherein an input pinion, a ring gear, and a differential are received in the cavity and wherein the pinion is rotatable relative to the carrier housing about a first axis, the ring gear is in mesh with the pinion, the ring gear being fixedly coupled to the differential, and wherein the differential is supported for rotation about a second axis relative to the carrier housing; and
a cover assembly including a cover configured to be secured to the carrier housing and close the opening, the cover including an interior surface configured to face the cavity and an exterior surface opposite the interior surface, the cover assembly further including a heat exchanger fixedly coupled to the exterior surface and having an inner surface facing the cover and an opposing outer surface, the cover assembly further including a cooling channel having an inlet port and an outlet port, wherein the cooling channel fluidly couples the outlet port to the inlet port in a U-shaped coolant flow path, and wherein the inlet port and the outlet port are configured to be coupled to a cooling system to control a flow of coolant through the cooling channel.

11. The vehicle driveline component of claim 10 wherein the cover includes a first groove and a second groove that is spaced apart from the first groove, and wherein the heat exchanger includes a fluid transfer conduit configured to fluidly connect the first and second grooves.

12. The vehicle driveline component of claim 11 wherein the heat exchanger includes a first side and a second side opposite the first side, and wherein the heat exchanger includes the first port and the second port at the first side and the fluid transfer conduit at the second side.

13. The vehicle driveline component of claim 11 wherein the first groove has a first serpentine shape and the second groove has a second serpentine shape different from the first serpentine shape.

14. The vehicle driveline component of claim 11 wherein a first leg of the U-shaped coolant flow path comprises the first groove, a second leg of the U-shaped coolant flow path comprises the second groove, and a bight section of the U-shaped coolant flow path comprises the fluid transfer conduit.

15. The vehicle driveline component of claim 10 wherein the cavity is configured to contain lubricating fluid, and wherein the cover includes a plurality of projections extending from the interior surface towards the cavity and configured to facilitate heat transfer from the lubricating fluid to the cover.

16. The vehicle driveline component of claim 10 wherein the heat exchanger includes a plurality of fins extending away from the outer surface.

17. The vehicle driveline component of claim 10 wherein the flow of coolant through the cooling channel is configured to transfer heat from the cover and the heat exchanger to the coolant.

18. A cooling system for a vehicle driveline component having a carrier housing defining a cavity and an opening, comprising:
a cover configured to be secured to the carrier housing and close the opening, the cover including an interior surface configured to face the cavity and an exterior surface opposite the interior surface;
a heat exchanger fixedly coupled to the exterior surface of the cover, the heat exchanger having an inner surface facing the cover and an outer surface opposite the inner surface; and
a cooling system, wherein the cover and the heat exchanger form a cooling channel that fluidly couples an inlet port and an outlet port in a U-shaped coolant flow path, and wherein the inlet port and the outlet port are configured to be coupled to the cooling system to control a flow of coolant through the cooling channel.
